(19) United States
(12) Patent Application Publication
(10) Pub. No.: US 2025/0068543 A1
(43) Pub. Date: Feb. 27, 2025

(54) DETERMINING SEMANTICS INFORMATION FOR PROGRAM STATEMENTS

(71) Applicant: International Business Machines Corporation, Armonk, NY (US)

(72) Inventors: Diptikalyan Saha, Bangalore (IN); Aniya Aggarwal, New Delhi (IN); Swagatam Haldar, Kolkata (IN); Alex Mathai, Mumbai (IN); Atul Kumar, Bangalore (IN)

(21) Appl. No.: 18/236,196

(22) Filed: Aug. 21, 2023

(51) Int. Cl. G06F 11/36

(52) U.S. Cl. CPC G06F 11/3608

(57) ABSTRACT

A computer-implemented method, according to one embodiment, includes: identifying statements in a software program. Values that satisfy path constraints of a given one of the statements are developed for ones of the identified statements that semantics information is not yet known. Outputs are produced by executing the given one of the statements using the generated values as inputs. Moreover, semantics information corresponding to the given one of the statements is determined by evaluating the generated values and corresponding outputs using a machine learning model. The semantics information is further used to generate a symbolic representation of the given one of the statements.

### BACKGROUND

The present invention relates to electronic devices, and more specifically, this invention relates to integrating with electronic devices to update software settings therein.

Electronic devices like mobile phones have continued to be adopted for a variety of situations in daily life. As electronic devices have become more advanced over time and gained functionality, they have been able to perform a wider array of actions. For instance, individuals can download software applications on their mobile phones. These software applications are each configured to utilize different characteristics of the mobile phones to perform specific actions.

The process of developing software that can perform these actions involves a review phase, during which the capabilities of the software are tested. This is often accomplished by traversing each of the different possible paths of the software (e.g., program). As these different paths are traversed, they are tested to verify accuracy and integration with a remainder of the software. Thus, by traversing each path of the software, the review phase is able to identify paths in the software that have errors.

This process has been performed manually in the past by conducting code review (sometimes referred to as peer review) of relatively simple coding languages like C, C++, and Java. As coding languages continue to become more complex, and software itself becomes more detailed, the process of accurately evaluating software capabilities has become an important task.

### SUMMARY

A computer-implemented method, according to one embodiment, includes: identifying statements in a software program. Values that satisfy path constraints of a given one of the statements are developed for ones of the identified statements that semantics information is not yet known. Outputs are produced by executing the given one of the statements using the generated values as inputs. Moreover, semantics information corresponding to the given one of the statements is determined by evaluating the generated values and corresponding outputs using a machine learning model. The semantics information is further used to generate a symbolic representation of the given one of the statements.

A computer program product, according to another embodiment, includes a computer readable storage medium having program instructions embodied therewith. The program instructions are readable by a processor, executable by the processor, or readable and executable by the processor, to cause the processor to: perform the foregoing method.

A system, according to yet another embodiment, includes: a processor, and logic integrated with the processor, executable by the processor, or integrated with and executable by the processor. Moreover, the logic is configured to: perform the foregoing method.

Other aspects and implementations of the present invention will become apparent from the following detailed description, which, when taken in conjunction with the drawings, illustrate by way of example the principles of the invention.

### BRIEF DESCRIPTION OF THE DRAWINGS

FIG. 1 is a diagram of a computing environment, in accordance with one approach.

FIG. 2 is a representational view of a distributed system, in accordance with one approach.

FIG. 3A is a flowchart of a method, in accordance with one approach.

FIG. 3B is a flowchart of a method, in accordance with one approach.

FIG. 4 is a representational view of a program tree structure, in accordance with one in-use example.

FIG. 5 is a flowchart of a method, in accordance with one embodiment of the present invention.

### DETAILED DESCRIPTION

The following description is made for the purpose of illustrating the general principles of the present invention and is not meant to limit the inventive concepts claimed herein. Further, particular features described herein can be used in combination with other described features in each of the various possible combinations and permutations.

Unless otherwise specifically defined herein, all terms are to be given their broadest possible interpretation including meanings implied from the specification as well as meanings understood by those skilled in the art and/or as defined in dictionaries, treatises, etc.

It must also be noted that, as used in the specification and the appended claims, the singular forms “a,” “an” and “the” include plural referents unless otherwise specified. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The following description discloses several preferred approaches of systems, methods and computer program products for automatically inspecting the various paths of a program and developing semantic representations of the statements in the various paths. For instance, implementations herein develop and/or apply machine learning models that are trained to generate the semantic representation of a given program statement. These machine learning models are thereby able to determine semantics of the statements in a reduced amount of time compared to conventional systems. For instance, these machine learning models may be dynamically trained in-use, e.g., as they are used to evaluate statements in the paths of a program. Implementations herein are thereby able to evaluate string and/or integer inputs associated with a program statement, and provide linear functions that represent the given program statement, e.g., as will be described in further detail below.

In one general embodiment, a computer-implemented method includes: identifying statements in a software program. Values that satisfy path constraints of a given one of the statements are developed for ones of the identified statements that semantics information is not yet known. Outputs are produced by executing the given one of the statements using the generated values as inputs. Moreover, semantics information corresponding to the given one of the statements is determined by evaluating the generated values and corresponding outputs using a machine learning model. The semantics information is further used to generate a symbolic representation of the given one of the statements.

In another general embodiment, a computer program product includes a computer readable storage medium having program instructions embodied therewith. The program instructions are readable by a processor, executable by the processor, or readable and executable by the processor, to cause the processor to: perform the foregoing method.

In yet another general embodiment, a system includes: a processor, and logic integrated with the processor, executable by the processor, or integrated with and executable by the processor. Moreover, the logic is configured to: perform the foregoing method.

Various aspects of the present disclosure are described by narrative text, flowcharts, block diagrams of computer systems and/or block diagrams of the machine logic included in computer program product (CPP) approaches. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product implementation (“CPP implementation” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as improved semantic development code at block 150 for automatically inspecting the various paths of a program and developing semantic representations of the statements in the various paths.

In addition to block 150, computing environment 100 includes, for example, computer 101, wide area network (WAN) 102, end user device (EUD) 103, remote server 104, public cloud 105, and private cloud 106. In this approach, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

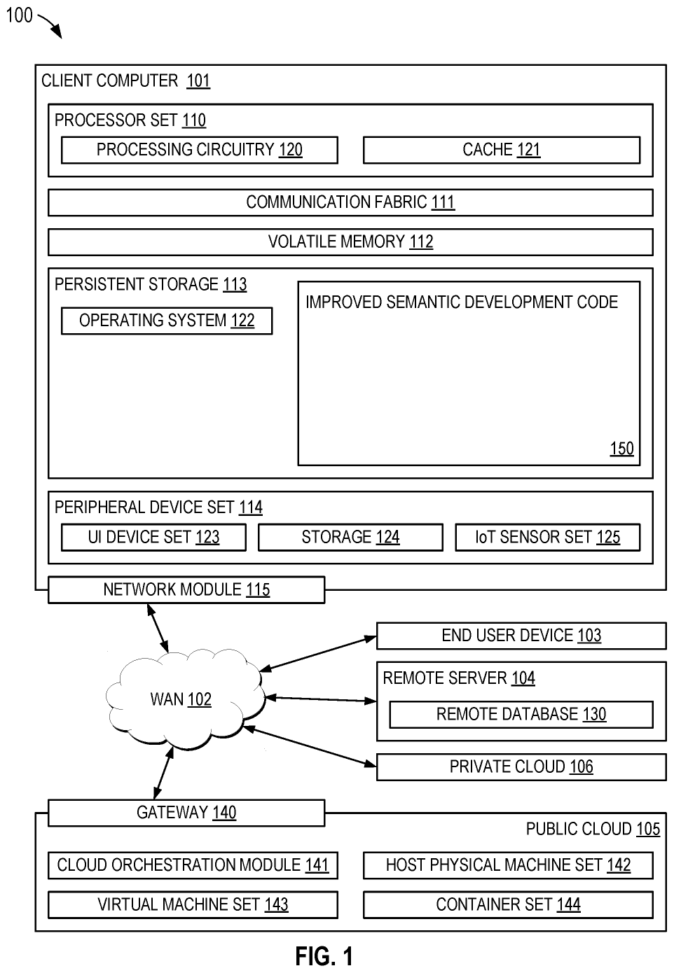

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 150 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various approaches, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some implementations, storage 124 may take the form of a quantum computing storage device for storing data in the form of qubits. In implementations where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some implementations, network control functions and network forwarding functions of network module 115 are performed on the same physical hardware device. In other implementations (for example, implementations that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some implementations, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some implementations, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other implementations a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this approach, public cloud 105 and private cloud 106 are both part of a larger hybrid cloud.

In some respects, a system according to various implementations may include a processor and logic integrated with and/or executable by the processor, the logic being configured to perform one or more of the process steps recited herein. The processor may be of any configuration as described herein, such as a discrete processor or a processing circuit that includes many components such as processing hardware, memory, I/O interfaces, etc. By integrated with, what is meant is that the processor has logic embedded therewith as hardware logic, such as an application specific integrated circuit (ASIC), a FPGA, etc. By executable by the processor, what is meant is that the logic is hardware logic; software logic such as firmware, part of an operating system, part of an application program; etc., or some combination of hardware and software logic that is accessible by the processor and configured to cause the processor to perform some functionality upon execution by the processor. Software logic may be stored on local and/or remote memory of any memory type, as known in the art. Any processor known in the art may be used, such as a software processor module and/or a hardware processor such as an ASIC, a FPGA, a central processing unit (CPU), an integrated circuit (IC), a graphics processing unit (GPU), etc.

Of course, this logic may be implemented as a method on any device and/or system or as a computer program product, according to various implementations.

As noted above, the process of developing software involves a review phase, during which operations of the software are tested. This is often accomplished by traversing each of the different possible paths of the software (e.g., program). As these different paths are traversed, they are tested to verify accuracy and integration with a remainder of the software. Thus, by traversing each path of the software, the review phase is able to identify paths in the software that have errors.

This process has been performed manually in the past by conducting code review (sometimes referred to as peer review). While this review process has been successful for relatively simple coding languages like C, C++, and Java, it has become significantly more time consuming as programming languages become more complex. For example, languages like Common Business Oriented Language (Cobol) and Advanced Business Application Programming (ABAP) include significantly more paths, leading to a large number of variations. As a result, the process of evaluating each path of a program becomes a significant bottleneck during the review process.

In sharp contrast to these conventional shortcomings, implementations herein are able to automatically inspect the various paths of a program and develop semantic representations of the statements in the various paths. For instance, implementations herein develop and/or apply machine learning models that are trained to generate the semantic representation of a given program statement.

These machine learning models are able to determine semantics of the statements in a reduced amount of time compared to conventional systems. For instance, these machine learning models may be dynamically trained in-use, e.g., as they are used to evaluate statements in the paths of a program. This allows the machine learning models to adapt to a given program, programming language structure, user preferences, etc., over time and with use. Implementations herein are thereby able to evaluate string and/or integer inputs associated with a program statement, and provide linear functions that represent the given program statement, e.g., as will be described in further detail below.

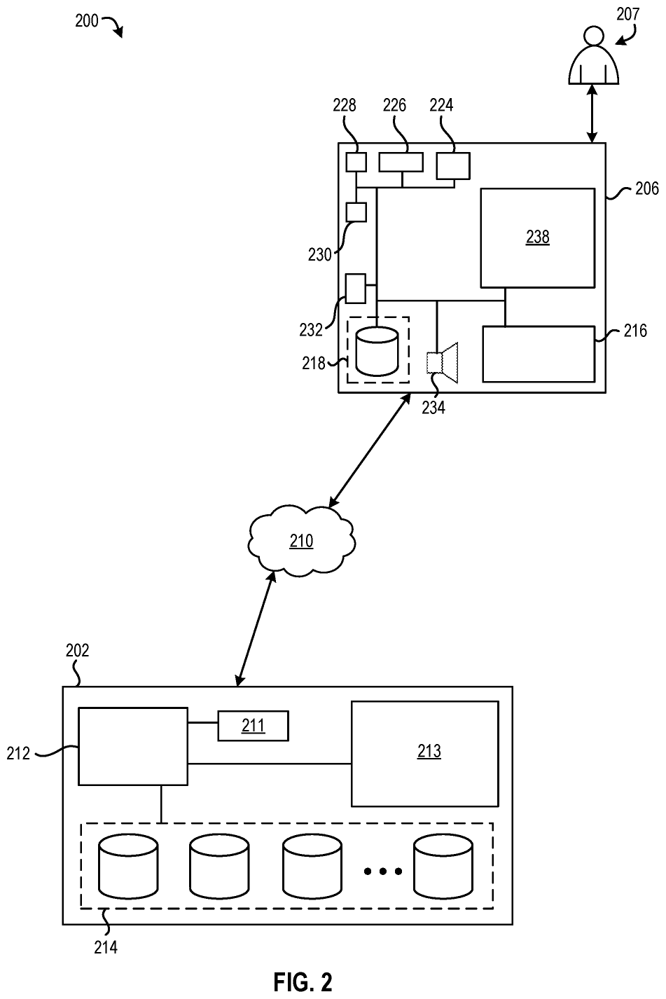

Looking now to FIG. 2, a system 200 having a distributed architecture is illustrated in accordance with one approach. As an option, the present system 200 may be implemented in conjunction with features from any other approach listed herein, such as those described with reference to the other FIGS., such as FIG. 1. However, such system 200 and others presented herein may be used in various applications and/or in permutations which may or may not be specifically described in the illustrative approaches or implementations listed herein. Further, the system 200 presented herein may be used in any desired environment. Thus FIG. 2 (and the other FIGS.) may be deemed to include any possible permutation.

As shown, the system 200 includes a central server 202 that is connected to an electronic device 206 accessible to the user 207. The electronic device 206 and central server 202 may thereby be separated from each other such that they are positioned in different geographical locations. For instance, the central server 202 and electronic device 206 are connected to a network 210.

The network 210 may be of any type, e.g., depending on the desired approach. For instance, in some approaches the network 210 is a WAN, e.g., such as the Internet. However, an illustrative list of other network types which network 210 may implement includes, but is not limited to, a LAN, a PSTN, a SAN, an internal telephone network, etc. As a result, any desired information, data, commands, instructions, responses, requests, etc. may be sent between user 207 and central server 202 using the electronic device 206, regardless of the amount of separation which exists therebetween, e.g., despite being positioned at different geographical locations.

However, it should be noted that two or more of the electronic device 206 and/or central server 202 may be connected differently depending on the approach. According to an example, which is in no way intended to limit the invention, edge compute nodes may be located relatively close to each other and connected by a wired connection, e.g., a cable, a fiber-optic link, a wire, etc.; etc., or any other type of connection which would be apparent to one skilled in the art after reading the present description. The term “user” is in no way intended to be limiting either. For instance, while users are described as being individuals in various implementations herein, a user may be an application, an organization, an information technology (IT) department, a preset process, etc. The use of “data” and “information” herein is in no way intended to be limiting either, and may include any desired type of details, e.g., depending on the type of software (e.g., program) being evaluated.

With continued reference to FIG. 2, the electronic device 206 and central server 202 are shown as having different configurations. For example, the central server 202 includes a large (e.g., robust) processor 212 coupled to a cache 211, a machine learning module 213, as well as a data storage array 214 having a relatively high storage capacity. The machine learning module 213 may include any desired number and/or type of machine learning models.

In preferred approaches, the machine learning module 213 includes machine learning models that have been trained to generate the semantic representation of a given program statement being evaluated. Accordingly, in some approaches the machine learning module 213 may be used to evaluate programs downloaded over network 210, received from electronic device 206, loaded from data storage array 214, etc. The machine learning module 213 at a central server 202 may thereby be used in some implementations to interpret the statements in a software program, by performing one or more of the operations in method 300, e.g., as will be described in further detail below.

With continued reference to FIG. 2, electronic device 206 includes a processor 216 coupled to memory 218. The processor 216 is also connected to a display screen 224, a computer keyboard 226, a computer mouse 228, a microphone 230, a camera 232, and an audio speaker 234. Accordingly, the processor 216 may receive inputs from user 207 using one or more of: the display screen 224 (e.g., using keys of a virtual computer keyboard, a touch screen, etc.), the computer keyboard 226, the computer mouse 228, the microphone 230, and/or the camera 232. The processor 216 may thereby be configured to receive inputs (e.g., text, sounds, images, motion data, etc.) from any of the components in electronic device 206, as entered by the user 207. These inputs typically correspond to information presented on the display screen 224 while the entries were received. Moreover, the inputs received may impact the information shown on display screen 224, data stored in memory 218, information collected from the microphone 230 and/or camera 232, status of an operating system being implemented by processor 216, etc.

Electronic device 206 also includes a machine learning module 238 which may be used to inspect software (e.g., programs). In preferred approaches, the machine learning module 238 includes machine learning models that have been trained to generate the semantic representation of a statement in a program being evaluated. Accordingly, in some approaches the machine learning module 238 may be used to evaluate programs downloaded over network 210, received from central server 202, loaded from memory 218, etc. The machine learning module 238 in electronic device 206 may thereby be used in some implementations to interpret the statements in a software program, by performing one or more of the operations in method 300 below, e.g., as will soon become apparent.

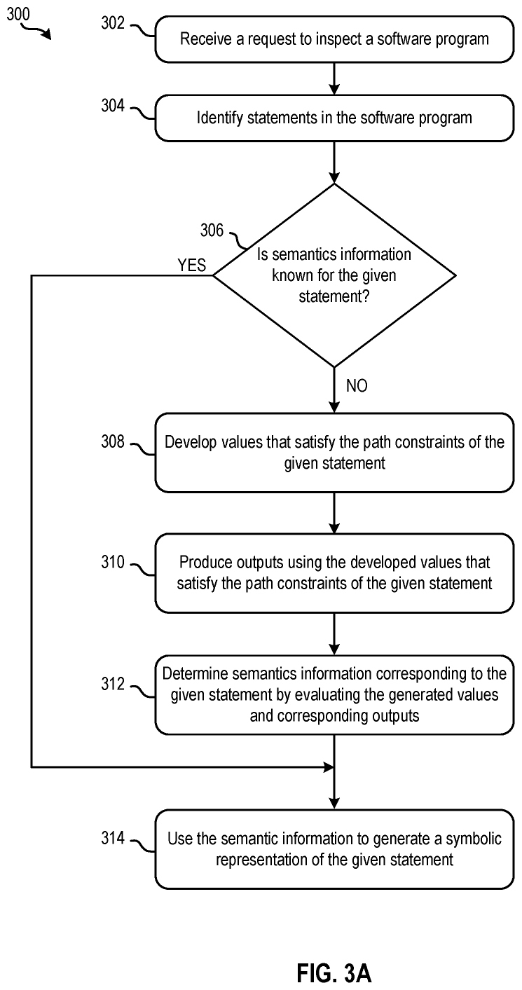

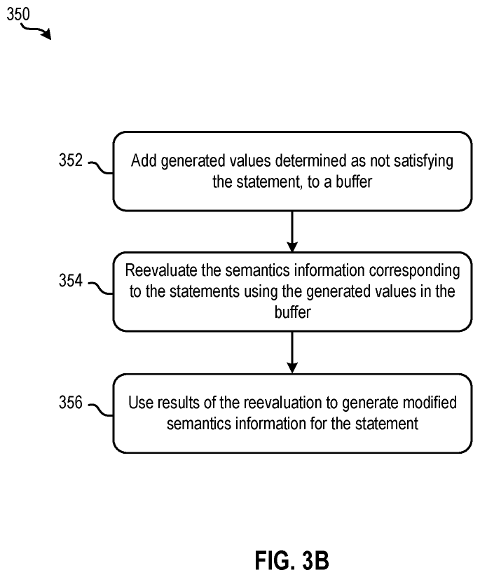

Now referring to FIG. 3A, a flowchart of a computer-implemented method 300 for interpreting the statements in a software program is shown according to one embodiment. The method 300 may be performed in accordance with the present invention in any of the environments depicted in FIGS. 1-2, among others, in various embodiments. Of course, more or less operations than those specifically described in FIG. 3A may be included in method 300, as would be understood by one of skill in the art upon reading the present descriptions.

Each of the operations in method 300 may be performed by any suitable component of the operating environment using known techniques and/or techniques that would become readily apparent to one skilled in the art upon reading the present disclosure. For example, in some implementations one or more of the operations in method 300 may be performed by a controller and machine learning module (e.g., see processor 216 and machine learning module 238 of FIG. 2 above). In various other implementations, the method 300 may be partially or entirely performed by a controller, a processor, etc., or some other device having one or more processors therein.

The processor, e.g., processing circuit(s), chip(s), and/or module(s) implemented in hardware and/or software, and preferably having at least one hardware component may be utilized in any device to perform one or more steps of the method 300. Illustrative processors include, but are not limited to, a central processing unit (CPU), an application specific integrated circuit (ASIC), a field programmable gate array (FPGA), etc., combinations thereof, or any other suitable computing device known in the art

As shown in FIG. 3A, operation 302 of method 300 includes receiving a request to inspect a software program. As alluded to above, requests to inspect software programs may be received from users, running applications, a remote location over a network, etc. It should also be noted that a “software program” is intended to include any desired type of software code written in any language that would be apparent to one skilled in the art after reading the present description.

In some approaches, the program being evaluated may be received along with the request in operation 302. For instance, program code may be attached to a request to inspect the code and evaluate the contents. In other approaches, the program may be stored in memory, e.g., at a location referenced in the received request.

In response to receiving the request, method 300 proceeds to operation 304 where the software program referenced in the received request is inspected. Specifically, operation 304 includes identifying statements in the software program. In some approaches, the software program is inspected using an annotated parser configured to identify the different statements therein. The annotated parser may be able to identify a use-definition chain that corresponds to each statement by inspecting the branches of a software program. According to an example, the annotated parser may be able to develop use-definition chains for the statements in a program using annotated grammar, e.g., as would be appreciated by one skilled in the art after reading the present description.

The statements identified in operation 304 may be retained at least temporarily in memory. For instance, in some approaches the identified statements may be stored in cache memory for a predetermined amount of time. The identified statements may additionally or alternatively be maintained in a lookup table stored at a central storage location. Additional information may also be determined in response to inspecting the program. For example, runtime information may be evaluated before executing the program. The size, programming language(s), etc., of the program may also be identified as a result of inspecting the various statements in the program. This additional information may also be stored in memory.

From operation 304, method 300 proceeds to operation 306. There, operation 306 includes determining whether semantics information is known about each of the identified statements. Operation 306 may thereby be performed (e.g., repeated) for each of the statements that are identified in operation 304.

With respect to the present description, the “semantics information” is intended to refer to information that describes the processes a computer follows when executing a program. The semantics information may be translated and represented in a number of different ways. For example, semantics information may be described by the relationship between the input and output of a program, an explanation of how the program is executed on a certain platform, etc. The semantics information may thereby be used to create a model of computation in some approaches.

Method 300 proceeds from operation 306 to operation 308 in response to determining that semantics information is not yet known for one of the statements identified in operation 304. There, operation 308 includes developing values that satisfy the path constraints of the given statement. In other words, operation 308 includes generating inputs that result in advancing past the present point in the program when used. It should also be noted that “values” may be expressed, stored, applied, etc., in any desired form. It follows that “values” as used herein may include numerical, alphabetical, etc. representations, and expressed as strings, integers, combinations thereof, etc., depending on the desired approach.

In some approaches, the values are developed using a dynamic symbolic execution module. Accordingly, operation 308 may actually include sending one or more instructions that result in (e.g., cause) the values that satisfy the present path constraints to be generated. The generated values are further evaluated by machine learning models in preferred approaches. It follows that additional values are preferably generated in response to reaching a new statement in the program. However, machine learning models operate differently and therefore use different numbers of input samples. It follows that additional values may be generated in response to determining a reserve of values falls below a predetermined threshold while running the machine learning models.

In some approaches, the values are generated by passing the path constraints and any constraints on inputs that correspond to a present program statement (e.g., node). This information may be obtained from an Application Programming Interface (API) specification corresponding to the program and/or the controller implementing the operations of method 300. The information is further provided to a Satisfiability Modulo Theories (SMT) solver which returns samples (e.g., values) that satisfy the previously described constraints.

According to an in-use example, which is in no way intended to limit the invention, the pseudocode below includes a recursive path learning algorithm that may be used to inspect a statement and determine values that satisfy the constraints of that statement.

```
Learn Paths(X, path_constraints):
  if |X| <= th:
      X_{gen} = Generate(path_constraints, Program P)
    X = X U X_{gen}
  constraint, X_{L}, X_{R} = Partition(X)
  LearnPaths(X_{L}, path_constraints \hat{ } constraint)
  LearnPaths(X_{R}, path_constraints \hat{ } (~constraint))
```

Here, the “Generate()” function generates new samples that adhere to the path constraints defined higher (e.g., earlier) in the sequence. Moreover, the “Partition()” function returns a constraint that minimizes the impurity of the resulting sets.

Again, this pseudocode above includes a recursive path learning algorithm according to an in-use example. This algorithm may be used to inspect a statement and determine values that satisfy the constraints of that statement, e.g., as would be appreciated by one skilled in the art after reading the present description.

With continued reference to FIG. 3A, operation 310 includes producing outputs using the values determined in operation 308. In other words, the generated values that satisfy the path constraints are used as inputs to execute the present statement. Outputs are produced as a result of executing the present statement using the various generated inputs. Moreover, each of the generated values used as inputs are preferably correlated with the respective output produced. In some approaches, this correlated input/output pair may be stored as a combined datapoint.

From operation 310, method 300 proceeds to evaluate the values input in the statement, and the corresponding information output. Accordingly, operation 312 includes determining semantics information corresponding to the present statement by evaluating the generated values and corresponding outputs. In preferred approaches, operation 312 includes using one or more machine learning models to evaluate the inputs of a statement in comparison to the outputs produced by the statement. According to one illustrative approach, the one or more machine learning models may include interpretable decision tree based artificial intelligence (AI) models. These AI (e.g., machine learning) models may be trained to deduce semantic information that represents (e.g., characterizes) the underlying statement, and define that semantic information in an applicable model. That model can further be used to better understand the statement that corresponds to the node in a program being evaluated.

Approaches herein are thereby able to inspect the various paths of a program automatically, allowing for software to be reviewed much more efficiently than has been conventionally achievable. As previously mentioned, conventional systems have required a much larger number of inputs to be generated and processed for each statement at each node of a program being evaluated. These conventional systems have thereby suffered efficiency limitations that have caused performance restrictions, particularly as software continues to become more complex.

The type and extent of semantics information that is determined for each statement varies depending on the implementation. For instance, software programs typically include data transformation statements as well as conditional statements (e.g., nodes). While it is preferred that semantics information is determined for different types of statements, it may be more desirable for certain types of statements. In some approaches only partial semantics information may be generated for transformation statements of a program (e.g., edge points on a tree structure). However, complete semantics information may be generated for conditional statements of a program (e.g., the nodes having forked paths). According to an example, which is in no way intended to limit the invention, partial semantics information may simply indicate the type of information a transformation statement outputs, while complete semantics information fully describes the processes a program follows when executed.

It follows that this semantic information provides valuable insight as to how a statement of the program functions, and how it directs the flow of the overarching method during implementation. Accordingly, the semantic information may be used to generate a symbolic representation of a statement. See operation 314. This symbolic representation of the statement may be further used to evaluate details of the program. For example, the symbolic representations of the various statements in a program may be used to perform dynamic symbolic execution on the program. Accordingly, the efficacy and efficiency of the program may be evaluated. Modifications may further be made to the program based on this evaluation, thereby resulting in an updated program that operates more efficiently as a result of dynamic adjustments that can be made over time, which in turn improves operation of the computer running the program.

As noted above, a program may include any number of statements (e.g., nodes). It follows that operations in method 300 may be repeated any desired number of times to process each statement in a program being evaluated. However, in the course of evaluating each of the statements in a program, issues may arise. For instance, the values developed in operation 308 may not actually satisfy path constraints of the statement.

Accordingly, a series of operations may be automatically performed in response to determining that some of the generated values do not result in an intended output. Looking now to FIG. 3B, a flowchart of a computer-implemented method 350 for reevaluating statements in a software program is shown according to one embodiment. Method 350 includes reevaluating statements in response to determining that some of the values generated for the statements do not result in an intended output. These faulty values indicate an issue exists with the feasibility of the path condition, which in turn indicates an incorrect model in the path. Thus, by collecting these invalid inputs and incrementally retraining the machine models used, implementations herein are able to improve accuracy of the models themselves.

The method 350 may be performed in accordance with the present invention in any of the environments depicted in FIGS. 1-3A, among others, in various embodiments. For example, method 350 may operate in the background while method 300 is performed. However, more or less operations than those specifically described in FIG. 3B may be included in method 350, as would be understood by one of skill in the art upon reading the present descriptions.

Each of the operations in method 350 may be performed by any suitable component of the operating environment using known techniques and/or techniques that would become readily apparent to one skilled in the art upon reading the present disclosure. For example, in some implementations one or more of the operations in method 350 may be performed by a controller and machine learning module (e.g., see processor 216 and machine learning module 238 of FIG. 2 above). In various other implementations, the method 350 may be partially or entirely performed by a controller, a processor, etc., or some other device having one or more processors therein.

As shown in FIG. 3B, operation 352 of method 350 includes adding generated values determined as not satisfying the corresponding statements, to a buffer. In other words, operation 352 includes adding any of the inputs generated in operation 308 of method 300 to a buffer in response to determining the inputs do not satisfy the statement. The buffer may be in cache, a designated logical and/or physical location in a storage array, etc., depending on the approach.

In some approaches, method 350 may advance from operation 352 to operation 354 in response to determining that each input generated for a given statement has been evaluated, e.g., before advancing to evaluate a next statement. In other approaches, method 350 advances to operation 354 in response to determining that all statements in a program have been inspected. In still other approaches, method 350 may advance to operation 354 in response to a predetermined number of generated inputs being added to the buffer.

There, operation 354 includes reevaluating the semantics information corresponding to the statements using the subset of generated values in the buffer. In other words, operation 354 includes comparing the faulty values accumulated in the buffer, to the statements themselves. For instance, one or more machine learning models may be used to reevaluate the semantics information as well as values that have been accumulated in a buffer. Any one or more of the implementations described with respect to method 300 may be implemented to perform the reevaluation of the semantics information.

For instance, the faulty values accumulated in the buffer may identify patterns and/or characteristics of the underlying statement that the machine learning models may be trained to identify and use to update the semantic information to more accurately represent the statement. Accordingly, operation 356 further includes using results of the reevaluation to generate modified semantics information for the given one of the statements.

In some approaches, the modified semantics information is directed back to operation 312 of FIG. 3A, e.g., such that it may be used to update the semantics information determination process. For example, the modified semantics information may be used to update the one or more machine learning models that are used to evaluate the inputs of a statement in comparison to the outputs produced by the statement. According to one illustrative approach, the modified semantics information may be used to train the one or more machine learning models to deduce semantic information that more accurately represents (e.g., characterizes) underlying statements.

Returning now to operation 306 of FIG. 3A, semantics information may already be known about some of the statements that are identified. It follows that method 300 proceeds directly to operation 314 in response to determining that semantics information is already known about the present statement. There, the known semantics information can be used to generate a symbolic representation of the statement, e.g., as described above.

It follows that method 300 may be performed to evaluate various software programs. Moreover, the inputs used to evaluate a statement in a program may be of different types depending on the implementation. For instance, in some approaches string inputs, integer inputs, and/or combinations thereof may be used as inputs to evaluate a statement in a program and develop semantics information that represents details of the statement. As noted above, this semantics information may further be used to develop symbolic representations (or “models”) of statements in the program, thereby gaining an accurate understanding of the program used to test the accuracy of the various statements included therein. Moreover, these symbolic representations are in the format of linear functions. In other words, method 300 outputs linear functions that model each statement in a program that is evaluated.

Implementations herein are thereby able to dynamically infer reusable semantics of statements in a program for symbolic execution. As noted herein, annotated grammar of the language may be used along with variables. Moreover, by applying machine learning models that are trained to infer statement semantics and produce reusable interpretable model for data transform statements. Implementations herein are able to achieve this by dynamically generating training data. For statements that semantics is unknown, multiple inputs are generated that satisfy the statement by solving the path constraints, e.g., using a constraint solver. Outputs may thereby be developed using the runtime. These generated inputs and outputs may further be used to learn the semantics of the corresponding statements. For example, an interpretable decision tree-based AI model which extends the existing decision tree-based model to infer expressions related to integer and strings as well as for classification and regression outputs may be developed. Moreover, the decision tree model may be configured to generate linear constraints that may be further processed, e.g., using a linear constraint solver. Moreover, in situations where an input generated does not actually solve a corresponding statement, a refinement is preferably performed. For instance, each of the inputs having issues may be collected and used to incrementally retrain the machine learning models used, before reevaluating the inputs (and other generated inputs).

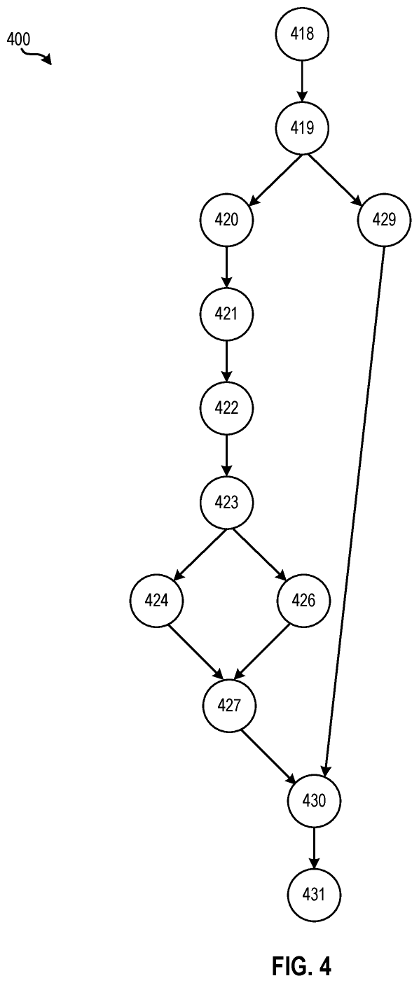

Looking now to FIG. 4, a program tree structure 400 having statements (e.g., nodes) 418, 419, 420, 421, 422, 423, 424, 426, 427, 429, 430, 431 is shown in accordance with an in-use example, which is in no way intended to be limiting. Each of the statements may thereby represent a corresponding node in a program. As an option, the present program tree structure 400 may be implemented in conjunction with features from any other embodiment listed herein, such as those described with reference to the other FIGS., such as FIGS. 2-3B.

Again, in accordance with the in-use example, statements corresponding to nodes 419, 420, 421, and 422 of the program tree structure 400 may read as follows:

| | |
|---|---|
| 419. | if score_1 > 40 and score_2 > 40 then |
| 420. | move 1 to pass |
| 421. | add score_1 to score_2 giving total |
| 422. | compute percent = (score_1*WT1+ score_2*WT2)/(WT1+WT2) |

It follows that the path conditions to reach the statement at node 422 include “score_1>40” and “score_2>40.” Based on this information and the remaining statements in the program, multiple different values may be generated for “score_1,” “score_2,” “WT1,” and “WT2,” such that the path conditions are met. These values may further be input into the statement to generate outputs that may also be stored for evaluation. As noted above, the generated inputs and corresponding outputs may be evaluated (e.g., compared) to determine semantic information about the corresponding statement. This semantic information may be further used to determine symbolic representations of a given program statement.

For example, the following sequence may be developed, trained, and executed in order to generate numeric values for “score_1,” “score_2,” “WT1,” and “WT2,” that also satisfy the path conditions.

```
build_hybrid_model(
  X = <score_1, WT1, score_2, WT2>,
  y = percent,
  path = [score_1 > 40 and score_2 >40]
)
```

By executing the sequence above, a hybrid decision tree regressor function f_{PERCENT} (<score_1, WT1, score_2, WT2>) is developed to determine a numerical value for “percent” as indicated.

This idea may be further generalized to develop an algorithm that may be implemented to develop a model that represents an unknown statement that corresponds to numerical values. For example, a (X, y)—y single regression output may be determined using a hybrid model (X, y, path), e.g., as indicated below.

```
if var(y) <= ϵ:
    return [<path, mean(y)>] # base case
  local_dt = DecisionTreeRegressor(max_depth=1).fit(X, y)
  local_lm = LinearRegressor(max_depth=1).fit(X, y)
  if accuracy(local_lm, X, y) > accuracy(local_dt, X, y):
    return [<path, local_lm.linear_function>]
  else:
    regions = [ ]
    feature, val = local_dt.split_node
    left = feature <= val
    right = feature > val
    left_regions = build_hybrid_model(X[left], y[left], path AND
(feature <= val))
    right_regions = build_hybrid_model(X[right], y[right], path AND
(feature > val))
    return left_regions + right_regions
```

The model developed may thereby be used to represent aspects of the statement (e.g., program node) that corresponds to the model. Some approaches involve creating models for string inputs rather than numerical values as described above. In such approaches, strings of inputs may be transformed using a program synthesis algorithm (e.g., transformation learning). This algorithm may include one or more machine learning models that are trained to generate learned sets of mappings based on input strings and the corresponding outputs formed.

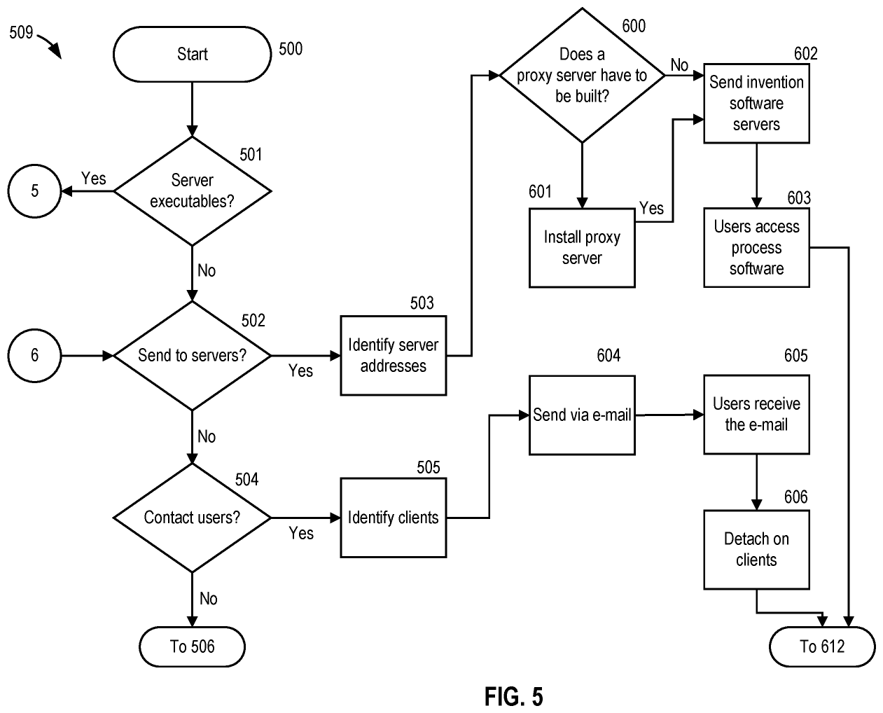

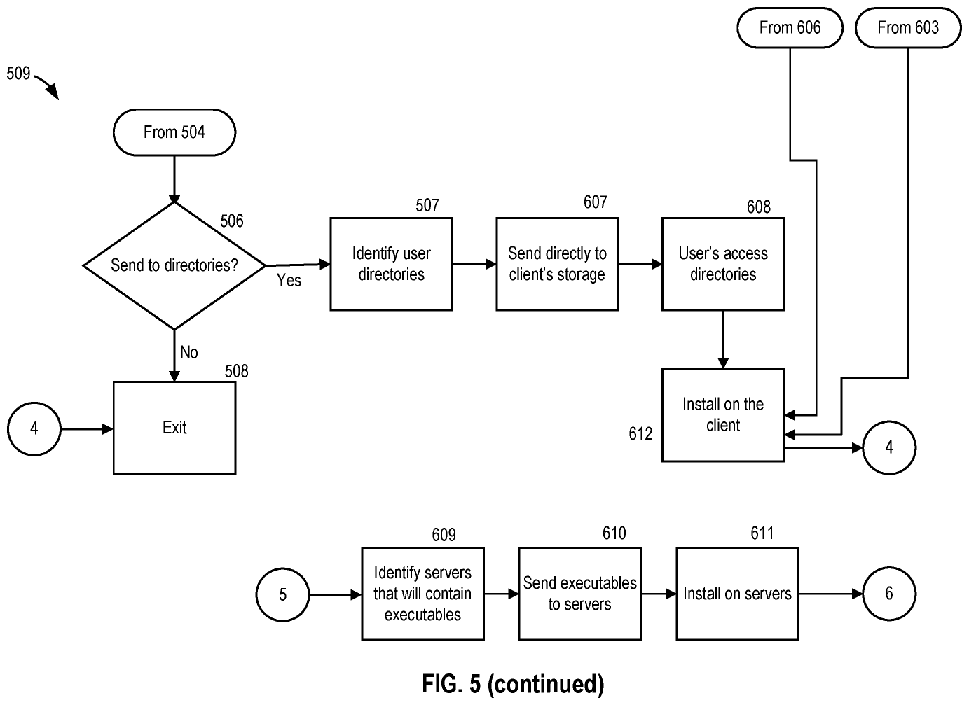

Now referring to FIG. 5, a flowchart of a method 509 is shown according to one embodiment. The method 509 may be performed in accordance with the present invention in any of the environments depicted in FIGS. 1-4, among others, in various embodiments. Of course, more or fewer operations than those specifically described in FIG. 5 may be included in method 509, as would be understood by one of skill in the art upon reading the present descriptions.

Each of the steps of the method 509 may be performed by any suitable component of the operating environment. For example, in various embodiments, the method 509 may be partially or entirely performed by a processing circuit, e.g., such as an IaC access manager, or some other device having one or more processors therein. The processor, e.g., processing circuit(s), chip(s), and/or module(s) implemented in hardware and/or software, and preferably having at least one hardware component, may be utilized in any device to perform one or more steps of the method 509. Illustrative processors include, but are not limited to, a central processing unit (CPU), an application specific integrated circuit (ASIC), a field programmable gate array (FPGA), etc., combinations thereof, or any other suitable computing device known in the art.

While it is understood that the process software associated with automatically inspecting the various paths of a program and developing semantic representations of the statements in the various paths may be deployed by manually loading it directly in the client, server, and proxy computers via loading a storage medium such as a CD, DVD, etc., the process software may also be automatically or semi-automatically deployed into a computer system by sending the process software to a central server or a group of central servers. The process software is then downloaded into the client computers that will execute the process software. Alternatively, the process software is sent directly to the client system via e-mail. The process software is then either detached to a directory or loaded into a directory by executing a set of program instructions that detaches the process software into a directory. Another alternative is to send the process software directly to a directory on the client computer hard drive. When there are proxy servers, the process will select the proxy server code, determine on which computers to place the proxy servers' code, transmit the proxy server code, and then install the proxy server code on the proxy computer. The process software will be transmitted to the proxy server, and then it will be stored on the proxy server.

With continued reference to method 509, step 500 begins the deployment of the process software. An initial step is to determine if there are any programs that will reside on a server or servers when the process software is executed (501). If this is the case, then the servers that will contain the executables are identified (609). The process software for the server or servers is transferred directly to the servers' storage via FTP or some other protocol or by copying though the use of a shared file system (610). The process software is then installed on the servers (611).

Next, a determination is made on whether the process software is to be deployed by having users access the process software on a server or servers (502). If the users are to access the process software on servers, then the server addresses that will store the process software are identified (503).

A determination is made if a proxy server is to be built (600) to store the

process software. A proxy server is a server that sits between a client application, such as a Web browser, and a real server. It intercepts all requests to the real server to see if it can fulfill the requests itself. If not, it forwards the request to the real server. The two primary benefits of a proxy server are to improve performance and to filter requests. If a proxy server is required, then the proxy server is installed (601). The process software is sent to the (one or more) servers either via a protocol such as FTP, or it is copied directly from the source files to the server files via file sharing (602). Another embodiment involves sending a transaction to the (one or more) servers that contained the process software, and have the server process the transaction and then receive and copy the process software to the server's file system. Once the process software is stored at the servers, the users via their client computers then access the process software on the servers and copy to their client computers file systems (603). Another embodiment is to have the servers automatically copy the process software to each client and then run the installation program for the process software at each client computer. The user executes the program that installs the process software on his client computer (612) and then exits the process (508).

In step 504 a determination is made whether the process software is to be deployed by sending the process software to users via e-mail. The set of users where the process software will be deployed are identified together with the addresses of the user client computers (505). The process software is sent via e-mail (604) to each of the users' client computers. The users then receive the e-mail (605) and then detach the process software from the e-mail to a directory on their client computers (606). The user executes the program that installs the process software on his client computer (612) and then exits the process (508).

Lastly, a determination is made on whether the process software will be sent directly to user directories on their client computers (506). If so, the user directories are identified (507). The process software is transferred directly to the user's client computer directory (607). This can be done in several ways such as, but not limited to, sharing the file system directories and then copying from the sender's file system to the recipient user's file system or, alternatively, using a transfer protocol such as File Transfer Protocol (FTP). The users access the directories on their client file systems in preparation for installing the process software (608). The user executes the program that installs the process software on his client computer (612) and then exits the process (508).

It will be clear that the various features of the foregoing systems and/or methodologies may be combined in any way, creating a plurality of combinations from the descriptions presented above.

It will be further appreciated that embodiments of the present invention may be provided in the form of a service deployed on behalf of a customer to offer service on demand.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method, comprising:
identifying statements in a software program;
for ones of the identified statements that semantics information is not yet known:
causing values that satisfy path constraints of a given one of the statements to be developed,
producing outputs by executing the given one of the statements using the generated values as inputs, and
determining semantics information corresponding to the given one of the statements by evaluating the generated values and corresponding outputs using a machine learning model; and
using the semantics information to generate a symbolic representation of the given one of the statements.

2. The computer-implemented method of claim 1, comprising:
in response to determining that executing the given one of the statements using a subset of the generated values as inputs does not produce an output, adding the subset of generated values to a buffer;
reevaluating the semantics information corresponding to the given one of the statements using the subset of generated values in the buffer; and
using results of the reevaluation to generate modified semantics information for the given one of the statements.

3. The computer-implemented method of claim 1, wherein the machine learning model is an interpretable decision tree based artificial intelligence model.

4. The computer-implemented method of claim 1, wherein the statements are identified by examining the software program with an annotated parser.

5. The computer-implemented method of claim 1, comprising:
for ones of the identified statements that semantics information is already known, using the known semantics information to generate a symbolic representation of the respective identified statements.

6. The computer-implemented method of claim 1, wherein the inputs are of a type selected from the group consisting of: string, integer, and combinations of string and integer.

7. The computer-implemented method of claim 6, wherein the outputs are linear functions.

8. The computer-implemented method of claim 1, wherein determining semantics information corresponding to the given one of the statements includes:
generating partial semantics information for ones of the statements that are data transformation statements; and
generating compete semantics information for ones of the statements that are conditional statements.

9. A computer program product, comprising a computer readable storage medium having program instructions embodied therewith, the program instructions readable by a processor, executable by the processor, or readable and executable by the processor, to cause the processor to:
identify statements in a software program;
for ones of the identified statements that semantics information is not yet known:
cause values that satisfy path constraints of a given one of the statements to be developed,
produce outputs by executing the given one of the statements using the generated values as inputs, and
determine semantics information corresponding to the given one of the statements by evaluating the generated values and corresponding outputs using a machine learning model; and
use the semantics information to generate a symbolic representation of the given one of the statements.

10. The computer program product of claim 9, wherein the program instructions are readable and/or executable by the processor to cause the processor to:
in response to determining that executing the given one of the statements using a subset of the generated values as inputs does not produce an output, add the subset of generated values to a buffer;
reevaluate the semantics information corresponding to the given one of the statements using the subset of generated values in the buffer; and
use results of the reevaluation to generate modified semantics information for the given one of the statements.

11. The computer program product of claim 9, wherein the machine learning model is an interpretable decision tree based artificial intelligence model.

12. The computer program product of claim 9, wherein the statements are identified by examining the software program with an annotated parser.

13. The computer program product of claim 9, wherein the program instructions are readable and/or executable by the processor to cause the processor to:
for ones of the identified statements that semantics information is already known, use the known semantics information to generate a symbolic representation of the respective identified statements.

14. The computer program product of claim 9, wherein the inputs are of a type selected from the group consisting of: string, integer, and combinations of string and integer.

15. The computer program product of claim 14, wherein the outputs are linear functions.

16. The computer program product of claim 9, wherein determining semantics information corresponding to the given one of the statements includes:
generating partial semantics information for ones of the statements that are data transformation statements; and
generating compete semantics information for ones of the statements that are conditional statements.

17. A system, comprising:
a processor; and
logic integrated with the processor, executable by the processor, or integrated with and executable by the processor, the logic being configured to:
identify statements in a software program;
for ones of the identified statements that semantics information is not yet known:
cause values that satisfy path constraints of a given one of the statements to be developed,
produce outputs by executing the given one of the statements using the generated values as inputs, and
determine semantics information corresponding to the given one of the statements by evaluating the generated values and corresponding outputs using a machine learning model; and
use the semantics information to generate a symbolic representation of the given one of the statements.

18. The system of claim 17, wherein the program instructions are readable and/or executable by the processor to cause the processor to:
in response to determining that executing the given one of the statements using a subset of the generated values as inputs does not produce an output, add the subset of generated values to a buffer;
reevaluate the semantics information corresponding to the given one of the statements using the subset of generated values in the buffer; and
use results of the reevaluation to generate modified semantics information for the given one of the statements.

19. The system of claim 17, wherein the machine learning model is an interpretable decision tree based artificial intelligence model, wherein the statements are identified by examining the software program with an annotated parser.

20. The system of claim 17, wherein determining semantics information corresponding to the given one of the statements includes:
generating partial semantics information for ones of the statements that are data transformation statements; and
generating compete semantics information for ones of the statements that are conditional statements.
